(19) United States
(12) Patent Application Publication
(10) Pub. No.: US 2024/0061190 A1
(43) Pub. Date: Feb. 22, 2024

(54) FIBER OPTIC CABLE WITH PULL GRIP AND METHOD OF MAKING AND USING SAME

(71) Applicant: CORNING RESEARCH & DEVELOPMENT CORPORATION, Corning, NY (US)

(72) Inventors: Terry Lee Cooke, Hickory, NC (US); Michael Todd Faulkner, Granite Falls, NC (US); Lars Kristian Nielsen, Denver, NC (US); Francisco Luna Pina, Hickory, NC (US)

(21) Appl. No.: 18/359,161

(22) Filed: Jul. 26, 2023

Related U.S. Application Data
(60) Provisional application No. 63/398,667, filed on Aug. 17, 2022.

(51) Int. Cl. G02B 6/38; G02B 6/44

(52) U.S. Cl. CPC G02B 6/3897; G02B 6/443

(57) ABSTRACT

A fiber optic cable includes an outer jacket, a plurality of optical fibers within the outer jacket, and a pull grip at an end of the fiber optic cable for pulling the cable through a pathway during installation of the cable. The pulling of the fiber optic cable through the pathway causes a tensile load to be imposed on the fiber optic cable. To accommodate the tensile load, the fiber optic cable further includes a load distribution member coupled to the pull grip and to the plurality of optical fibers. The load distribution member distributes the tensile load on the fiber optic cable over the plurality of optical fibers such that the plurality of optical fibers collectively provides the tensile strength to support the tensile load during routing of the fiber optic cable through the pathway. In this way, strength members may be omitted from the design of the cable and more optical fibers may fit within existing pathways. A method of making and a method of using such a fiber optic cable is also disclosed.

### PRIORITY APPLICATION

This application claims the benefit of priority of U.S. Provisional Application No. 63/398,667, filed on Aug. 17, 2022, the content of which is relied upon and incorporated herein by reference in its entirety.

### TECHNICAL FIELD

This disclosure relates generally to fiber optic cables, and more particularly to a fiber optic cable having strength members omitted from their construction and a pull grip connected to the fiber optic cable that transfers the tensile forces imposed on the pull grip during installation of the cable in a pathway to the optical fibers carried by the fiber optic cable in a distributed manner. The disclosure also relates to a method of making and using the fiber optic cable having such a pull grip.

### BACKGROUND

The large amount of data and other information transmitted over the internet has led businesses and other organizations to develop large scale datacenters for organizing, processing, storing and/or disseminating large amounts of data. Datacenters contain a wide range of information technology (IT) equipment including, for example, servers, networking switches, routers, storage subsystems, etc. Datacenters further include a large amount of cabling and racks to organize and interconnect the IT equipment in the datacenter. Modern datacenters may include multi-building campuses having, for example, one primary or main building and a number of auxiliary buildings in close proximity to the main building. All the buildings on the campus are interconnected by a local fiber optic network.

More particularly, each of the auxiliary buildings are typically coupled to the main building by one or more high fiber-count optical cables referred to as trunk cables or interconnect cables. Each trunk cable may include, for example, 3,456 optical fibers, and even higher fiber-count trunk cables may be common in the future. To facilitate connections between the various buildings on the campus, conduits or other cable ducts configured to carry fiber optic cables are typically installed between the buildings when the datacenter is constructed. Moreover, to provide optical connectivity in the main building, for example, the optical fibers of a trunk cable are typically spliced to optical fibers of indoor cables (such as in a splice cabinet of the like) that route to the IT equipment in the main building. The indoor cables are similarly routed through interior conduits, ducts, raceways, etc. (“pathways”) within the buildings during the construction of the datacenter.

To route the fiber optic cables through the conduits or other pathways during original installation or during an upgrade with new or additional fiber optic cables, one end of the cable is typically provided with a pull grip assembly (referred to as a “pull grip” or “pulling grip”). A tension member that extends through the conduit is then coupled to the pull grip and the fiber optic cable is pulled through the conduit by the tension member. Depending on several factors, including the size of the fiber optic cable, the length of the conduit, and the resistance met during the pulling of the cable through the conduit, the fiber optic cable may be subjected to relatively high tensile forces, e.g., on the order of several hundreds of pounds of force. Many current fiber optic cables include one or more strength members (e.g., glass reinforced polymer rods, steel rods, aramid yarns, or the like) that extend the length of the fiber optic cable to accommodate the tensile loads applied to the fiber optic cable during their installation through the conduit. In many cases, the end of the fiber optic cable may be unterminated or pre-terminated with one or more connectors. In the latter case, the fiber optic cable typically includes an epoxy-filled furcation housing, at which the cable jacket and strength members are terminated, and beyond which the connectorized optical fibers of the cable are provided for connection to other fiber optic devices or equipment. In conventional arrangements, pull grips typically extend over the (unjacketed) optical fibers downstream of the furcation housing, to protect the optical fibers and associated connectors, and attach to the furcation housing. In this way, the tensile forces applied to the pull grip are transferred to the strength members of the fiber optic cable via the furcation housing without the tensile load path extending through the more fragile optical fibers carried by the fiber optic cable.

While current implementations of pull grips on fiber optic cables and their use in routing fiber optic cables through existing conduits are satisfactory for their intended purpose, with increased demand for bandwidth, manufacturers and installers have identified a number of drawbacks to existing arrangements. For example, in one approach, to meet future network bandwidth demand, the number of optical fibers may be increased. The challenge here is how to increase the number of optical fibers when, in many cases, aspects of the physical infrastructure have already been established or determined (and realizing that rebuilding the physical infrastructure is a high-cost option). In other words, the challenge becomes how to increase the number of optical fibers in existing conduits, ducts, raceways, etc. having a fixed size. Indeed, the efficient utilization of space (i.e., more capacity in less space) has become a primary design driver for manufacturers and installers as the demand for bandwidth has increased.

With this in mind, there is a desire to provide fiber optic cables with a smaller cross-sectional area. This will allow more fiber optic cables, and thus more optical fibers, to fit within the existing conduits and other pathways. While many factors may impact the cross-sectional area of the fiber optic cable, including the diameter of each optical fiber itself, the thickness of the outer jacket, etc., manufacturers have realized that the strength members that extend along the length of the fiber optic cable also contribute to the cross-sectional area of the fiber optic cable. In addition to the above, the strength members generally make the fiber optic cable more rigid (i.e., less flexible/bendable), and can therefore make the routing of the fiber optic cable through the bends and turns in a pathway more difficult. Navigation of these turns in the pathway with a relatively stiff fiber optic cable often requires an increase in the tensile load applied to the fiber optic cable.

Furthermore, manufacturers have also realized that the furcation housing adjacent the end of conventional fiber optic cables may also increase the cross-sectional area of the cable. As noted above, the furcation housing effectively provides an attachment point for the pull grip to access the strength members of the fiber optic cable.

If manufacturers omit strength members and perhaps even furcation housings from the construction of their fiber optic cables, the challenges of how to pull such fiber optic cables through conduits, ducts, raceways, etc. without damaging the optical fibers carried by the fiber optic cable remain.

### SUMMARY

In one aspect of the disclosure, a fiber optic cable having an outer jacket, a plurality of optical fibers carried within the outer jacket, and a pull grip at an end of the fiber optic cable for pulling the fiber optic cable through a pathway during installation of the cable, for example, is disclosed. The pulling of the fiber optic cable through the pathway causes a tensile load to be imposed on the fiber optic cable. To accommodate the tensile load, the fiber optic cable further includes a load distribution member coupled to the pull grip and to the plurality of optical fibers. The load distribution member is configured to distribute the tensile load imposed on the fiber optic cable over the plurality of optical fibers such that the plurality of optical fibers collectively provides the tensile strength to support the tensile load on the fiber optic cable during routing of the fiber optic cable through the pathway.

By distributing the tensile load experienced during routing of the fiber optic cable through the pathway to the plurality of optical fibers carried by the fiber optic cable, strength members typically included in the fiber optic cable may be omitted without increased risk of damage to the optical fibers. The omission of the strength members provides fiber optic cables with reduced cross-sectional dimensions. Accordingly, more fiber optic cables may be able to fit within existing conduits or other pathways in the physical infrastructure of the network. Additionally, the fiber optic cable of this aspect of the disclosure further allows furcation housings to be omitted from the fiber optic cable. This may further provide fiber optic cables with reduced cross-sectional dimensions. For the optical fibers to collectively provide the tensile strength for accommodating the tensile loads imposed on the fiber optic cable during routing, there must be a relatively large number of optical fibers. In one embodiment, the number of optical fibers carried in the fiber optic cable may exceed 1,000 optical fibers, preferably exceed 1,300 optical fibers, and more preferably exceed 1,500 optical fibers. In one embodiment, the fiber optic cable may be a trunk cable configured to be routed through an external conduit, such as at a datacenter. In another embodiment, the fiber optic cable may be an indoor cable configured to be routed through an interior conduit or other pathway within a main building or an auxiliary building of the datacenter.

In one embodiment, the load distribution member may include a squeeze tube having an internal passage through which the plurality of optical fibers may extend. The squeeze tube is configured to apply a squeeze pressure to the plurality of optical fibers extending therethrough across a contact surface area at an interface between the squeeze tube and the plurality of optical fibers. In one embodiment, the squeeze tube may be configured so that the squeeze pressure is variable. For example, in one embodiment, the squeeze tube may be configured such that the squeeze pressure is a function of the tensile load imposed on the fiber optic cable. Thus, an increase in the tensile load on the fiber optic cable causes a corresponding increase in the squeeze pressure on the plurality of optical fibers and a decrease in the tensile load on the fiber optic cable causes a corresponding decrease in the squeeze pressure on the plurality of optical fibers. In an exemplary embodiment, the squeeze tube may include a self-constricting tubular mesh reactive to a variable tensile load on the fiber optic cable. Elongations of the tubular mesh in a longitudinal direction cause a constriction in the tubular mesh in a radial direction.

In one embodiment, at least a portion of the pull grip, such a tubular body thereof, may be formed by the load distribution member, such as an extension thereof. In another embodiment, the pull grip may include a tubular body having a proximal end, a distal end, and an internal passage; a pulling plug at the proximal end of the tubular body for connection to a tension member for pulling the fiber optic cable through the pathway; and a bushing at the distal end of the tubular body, the bushing permitting the plurality of optical fibers to pass into the internal passage of the tubular body. In one embodiment, tubular body may be relatively rigid for protecting the optical fibers and any connectors associated therewith during the routing of the fiber optic cable through the pathway. In an alternative embodiment, the tubular body may be more flexible so as to navigate turns in the pathway in an improved manner. In one embodiment, the bushing may include one or more seal members for creating a seal between the bushing and the tubular member of the pull grip.

In this embodiment, the load distribution member may further include a force transfer band, and the fiber optic cable may include a releasable connection band connecting the bushing of the pull grip and the force transfer band of the load distribution member. In this way, the tensile load imposed on the pull grip may be transferred to the load distribution member through the releasable connection band. In one embodiment, the releasable connection band may include a rip cord for severing the connection band and breaking the connection between the pull grip and the load distribution member. Upon severance of the connection band, the pull grip may be slidingly removable from the end of the fiber optic cable to expose the plurality of optical fibers and any connectors associated therewith.

In one embodiment, the fiber optic cable may further include a protective tube covering at least a portion of the load distribution member. The protective tube may be connected to the outer jacket of the fiber optic cable, such as through welding or through a connection band. The releasable connection band may also engage the protective tube. The protective tube and the welded connection/connection band to the outer jacket of the finer optic cable prevents water or other liquids from accessing the optical fibers.

The transfer of the tensile load from the load distribution member to the plurality of optical fibers occurs through the contact surface area at the interface therebetween. The contact surface area is of a sufficient size to permit the transfer of the tensile loads in a relatively uniform and low-peak manner. By way of example, the contact surface area through which the tensile load is transferred may be no less than about 7,500 mm². In one embodiment, the contact surface area through which the tensile load is transferred may be between about 7,500 mm² and about 15,000 mm². In an alternative embodiment, the contact surface area through which the tensile load is transferred may have a length along the plurality of optical fibers, and the ratio of the length of the contact surface area and an outer diameter of the plurality of optical fibers may be no less than about 10. In one embodiment, the ratio of the length of the contact surface area and the outer diameter of the plurality of optical fibers may be between about 10 and about 14.

In a second aspect of the disclosure, a method of preparing a fiber optic cable for installation through a pathway is disclosed. The fiber optic cable includes an outer jacket and a plurality of optical fibers carried within the outer jacket. The method includes removing a portion of the outer jacket at one end of the fiber optic cable to expose a working length of the plurality of optical fibers; disposing a load distribution member over at least a portion of the working length of the plurality of the optical fibers; providing a pull grip adjacent the end of the fiber optic cable, the pull grip configured to be subjected to a tensile load during routing of the fiber optic cable through the pathway; and connecting the pull grip to the load distribution member such that the tensile load imposed on the pull grip is transferred to the load distribution member. The load distribution member is configured to distribute the tensile load imposed on the fiber optic cable over the plurality of optical fibers such that the plurality of optical fibers collectively provides the tensile strength to support the tensile load on the fiber optic cable.

In one embodiment, disposing the load distribution member may further include disposing a squeeze tube over the portion of the working length of the plurality of optical fibers, the squeeze tube having an internal passage through which the plurality of optical fibers extends, and the squeeze tube being configured to apply a squeeze pressure to the plurality of optical fibers. In one embodiment, the squeeze tube may be configured to apply a variable squeeze pressure to the plurality of optical fibers. For example, the squeeze tube may be configured to apply a squeeze pressure to the plurality of optical fibers that is a function of the tensile load imposed on the fiber optic cable. In one embodiment, disposing the squeeze tube over the plurality of optical fibers may further include disposing a self-constricting tubular mesh over the portion of the working length of the plurality of optical fibers.

In one embodiment, disposing the load distribution member over the plurality of the optical fibers may further include disposing the load distribution member over the portion of the working length of the plurality of optical fibers so that a contact surface area between the load distribution member and the plurality of optical fibers is no less than about 7,500 mm². For example, in one embodiment, the contact surface area between the load distribution member and the plurality of optical fibers may be between about 7,500 mm² and about 15,000 mm². In an alternative embodiment, disposing the load distribution member over the plurality of the optical fibers may further include disposing the load distribution member of the portion of the working length of the plurality of optical fibers to define a contact surface area extending along a length of the optical fibers, wherein the ratio of the length of the contact surface area and an outer diameter of the plurality of optical fibers is no less than 10. For example, in one embodiment, the ratio of the length of the contact surface area and the outer diameter of the plurality of optical fibers may be between about 10 and about 14.

In one embodiment, connecting the pull grip to the load distribution member may further include connecting a releasable connection band to both the pull grip and the load distribution member. In this embodiment, upon the connection band being released, the pull grip may be slidingly removable from the end of the fiber optic cable to expose the plurality of optical fibers and any connectors associated therewith.

In a third aspect of the disclosure, a method of routing a fiber optic cable through a pathway, such as in a datacenter environment, is disclosed. The fiber optic cable includes an outer jacket, a plurality of optical fibers carried within the outer jacket, and a pull grip connected to an end of the fiber optic cable. The method includes attaching a tension member to the pull grip and pulling the fiber optic cable through the pathway using the tension member, the pulling of the fiber optic cable imposing a tensile load on the fiber optic cable; and distributing the tensile load imposed on the fiber optic cable to the plurality of optical fibers such that the plurality of optical fibers collectively provides the tensile strength to support the tensile load on the cable. In one embodiment, the method may further include, after the fiber optic cable has been pulled through the pathway, removing the pull grip the fiber optic cable to expose the plurality of optical fibers.

In one embodiment, distributing the tensile load may further include providing a load distribution member and coupling the load distribution member to the pull grip and to the plurality of optical fibers, and transferring the tensile load on the pull grip to the plurality of optical fibers through the load distribution member. In one embodiment, the load distribution member may include a squeeze tube having an internal passage, the plurality of optical fibers extending through the internal passage, wherein the squeeze tube is configured to apply a squeeze pressure to the plurality of optical fibers, and wherein the squeeze pressure is a function of the tensile load transferred through the squeeze tube. In one embodiment, providing the load distribution member may further include providing a self-constricting tubular mesh.

Additional features and advantages will be set forth in the detailed description which follows, and in part will be readily apparent to those skilled in the technical field of optical connectivity. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a schematic illustration of a datacenter campus according to an exemplary embodiment of the disclosure;

FIG. 2 is a cross-sectional view of a fiber optic cable having strength members that accommodate tensile loads imposed on the fiber optic cable during installation through a pathway;

FIG. 3 is a cross-sectional view of an indoor fiber optic cable according to an embodiment of the disclosure;

FIG. 4 is a cross-sectional view of a fiber optic cable according to an embodiment of the disclosure where strength members are omitted from the cable;

FIG. 5 is a perspective view of a fiber optic cable having a pull grip in accordance with an embodiment of the disclosure;

FIG. 6 is a perspective view of the fiber optic cable of FIG. 5 illustrating the outer sheath stripped from the cable to expose a working length of the optical fibers;

FIG. 7 is a perspective view of the fiber optic cable of FIG. 6 illustrating a load distribution member disposed over a portion of the working length of the optical fibers;

FIG. 8 is a perspective view of the fiber optic cable of FIG. 7 illustrating a protective tube disposed over the load distribution member;

FIG. 9 is a perspective view of the fiber optic cable of FIG. 8 illustrating a force transfer band attached to the load distribution member;

FIG. 10 is a perspective view of the fiber optic cable of FIG. 9 illustrating a bushing of the pull grip disposed over a portion of the working length of the optical fibers adjacent the force transfer band;

FIG. 11 is a perspective view of the fiber optic cable of FIG. 10 illustrating the tubular body and the pull plug of the pull grip being connected to the bushing of the pull grip; and

FIG. 12 is a perspective view of a fiber optic cable having a pull grip in accordance with another embodiment of the disclosure.

### DETAILED DESCRIPTION

Various embodiments will be further clarified by examples in the description below. In general, the description relates to a fiber optic cable having a pull grip that obviates the need for having strength members in the cable by distributing the tensile loads applied to the pull grip during, for example, the routing of the fiber optic cable in a pathway, to the plurality of optical fibers carried in the fiber optic cable. More particularly, the pull grip is coupled to the plurality of optical fibers by a load distribution member that utilizes the collective tensile strength of the numerous optical fibers extending through the fiber optic cable. Thus, while one or a select few of the optical fibers would not provide sufficient tensile strength to support the tensile loads on the cable during routing, when there is a high number of optical fibers, the tensile strength of that collective group of optical fibers may provide sufficient strength to eliminate the strength members from the design of the fiber optic cable. The load distribution member may include a squeeze tube that applies a squeeze pressure to the plurality of optical fibers over a sufficiently large contact surface area to maintain peak tensile loads below a threshold that would damage the optical fibers. The pressure of the squeeze tube may depend on the tensile loading on the fiber optic cable. Such a squeeze tube may be provided by a self-constricting tubular mesh. This and other features of fiber optic cable according to embodiments of the disclosure are discussed in more detail below.

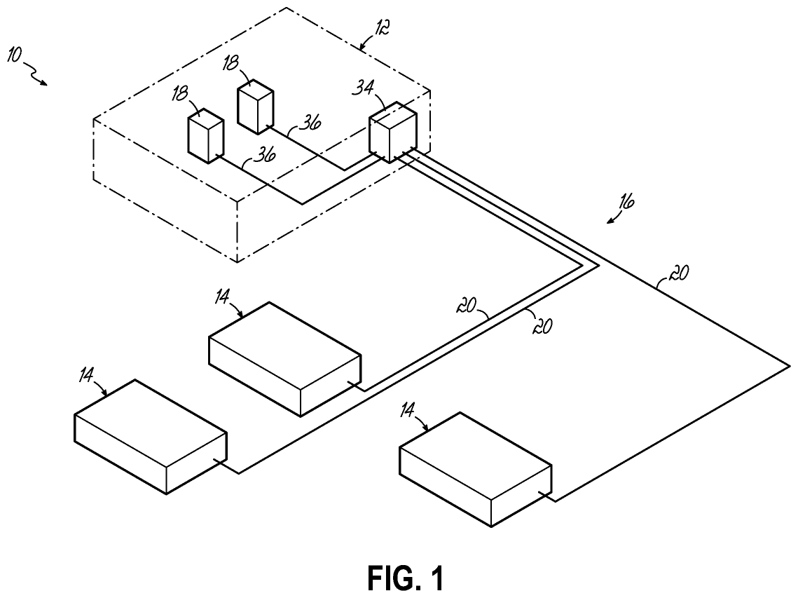

As illustrated in FIG. 1, a modern-day datacenter 10 may include a collection of buildings (referred to as a datacenter campus) having, for example, a main building 12 and one or more auxiliary buildings 14 in close proximity to the main building 12. While three auxiliary buildings are shown, there may be more or less depending on the size of the campus. The datacenter 10 provides for a local fiber optic network 16 that interconnects the auxiliary buildings 14 with the main building 12. The local fiber optic network 16 allows IT equipment 18 in the main building 12 to communicate with various IT equipment (not shown) in the auxiliary buildings 14. In the exemplary embodiment shown, the local fiber optic network 16 includes trunk cables 20 extending between the main building 12 and each of the auxiliary buildings 14.

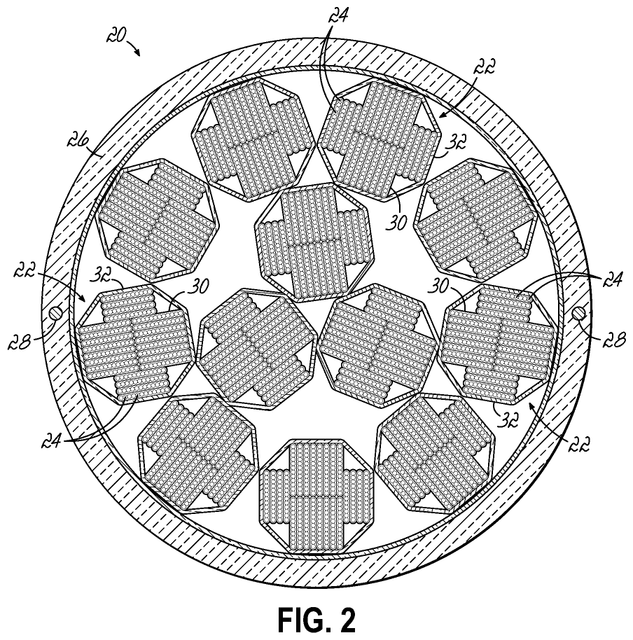

As illustrated in FIG. 2, conventional trunk cables 20 generally include a high fiber-count arrangement of optical fibers for passing data and other information through the local fiber optic network 16. The trunk cable 20 in the example shown includes a plurality of routable subunits 22, and each routable subunit 22 is configured to carry a pre-selected number of optical fibers 24. Although the trunk cable 20 is shown as including twelve routable subunits 22, the number of subunits 22 may be more or less than this number in alternative embodiments. The routable subunits 22 may be arranged within an outer protective sheath 26 (“outer jacket 26”), as is generally known in the industry. The outer jacket 26 generally includes a plurality of strength members, generally shown at 28, that extend along the length of the trunk cable 20 and provide tensile strength to the cable 20 during installation of the trunk cable 20 in a pathway (e.g., a conduit). In the example embodiment shown, strength members 28 are on opposing sides of the trunk cable 20 but may be located in alternative locations in the trunk cable 20. As mentioned above, each of the routable subunits 22 is configured to carry a pre-selected number of optical fibers 24. By way of example and without limitation, each routable subunit 22 may be configured to carry 288 optical fibers 24. It should be recognized, however, that more or less optical fibers 24 may be carried by each of the routable subunits 22.

The optical fibers 24 in the routable subunits 22 may be configured as a plurality of fiber optic ribbons 30 (“ribbons 30”). Each ribbon 30 includes a plurality of the optical fibers 24 arranged in a generally side-by-side manner (e.g., a linear array, as shown, or a rolled/folded array). Such ribbons are generally known in the art and thus will not be further described herein. In one embodiment, for example, each ribbon 30 may be configured to include twelve optical fibers 24. It should be recognized, however, that each ribbon 30 may include more or less optical fibers 24 in various alternative embodiments. The ribbons 30 of a routable subunit 22 may be arranged within a subunit sheath 32 (“subunit jacket 32”), which may be a thin layer of material that has been extruded over the ribbons 30. In the example illustrated in FIG. 1, the trunk cables 20 from the auxiliary buildings 14 are routed to a distribution cabinet 34 housed in the main building 12. In alternative embodiments, there may be multiple distribution cabinets 34 in the main building for receiving the trunk cables 20.

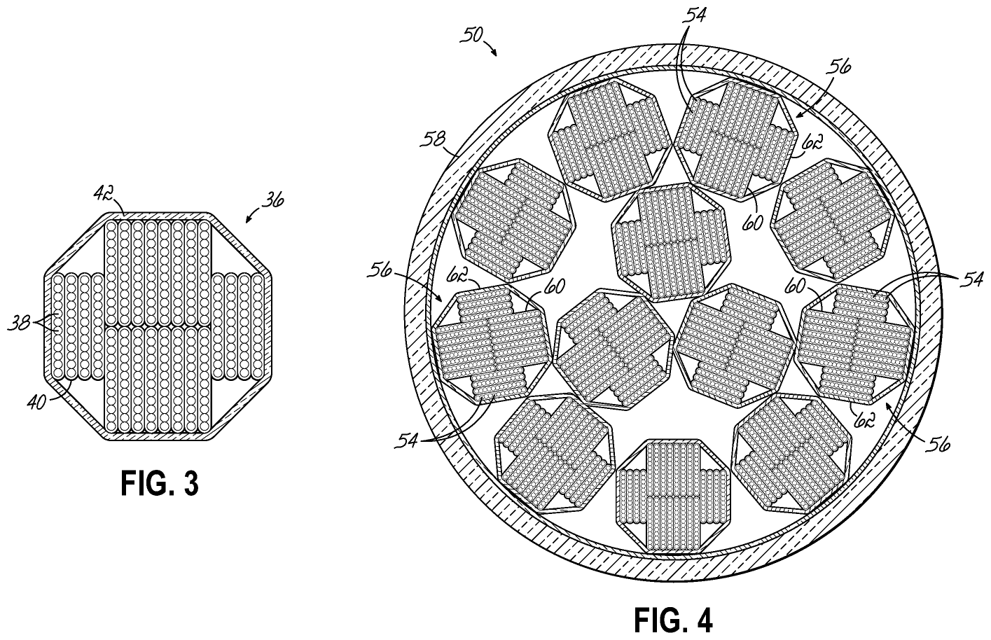

Within the main building 12, a plurality of indoor fiber optic cables 36 (“indoor cables 36”) are routed between the equipment 18 and the one or more distribution cabinets 34. In an exemplary embodiment and as illustrated in FIG. 3, each of the indoor cables 36 may be configured similar to a routable subunit 22, at least in terms of fiber count and fiber groupings, and thereby be configured to carry a pre-selected number of optical fibers 38. By way of example and without limitation, each indoor cable 36 may be configured to carry 288 optical fibers 38. It should be recognized, however, that more or less optical fibers 38 may be carried by each of the indoor cables 36. In an exemplary embodiment, the optical fibers 38 in the indoor cables 36 may be configured as a plurality of fiber optic ribbons 40 (“ribbons 40”), wherein each ribbon 40 includes a plurality of optical fibers 38 arranged in a generally side-by-side manner (e.g., in a linear array or in a rolled/folded array). Again, such ribbons are generally known in the art and thus will not be further described herein. In one embodiment, for example, each ribbon 40 may be configured to include twelve optical fibers 38. It should be recognized, however, that each ribbon 40 may include more or less optical fibers 38 in various alternative embodiments. The ribbons 40 of an indoor cable 36 may be arranged within an outer protective sheath 42 (“cable outer jacket 42” or simply “cable jacket 42”), as is generally known in the industry.

Although only the interior of the main building 12 is schematically shown in FIG. 1 and discussed above, each of the auxiliary buildings 14 may house similar equipment for similar purposes. Thus, although not shown, each of the trunk cables 20 may be routed to one or more distribution cabinets 34 in one of the auxiliary buildings 14 in a manner similar to that described above. Furthermore, each of the auxiliary buildings 14 may include indoor cables 36 that extend between IT equipment 18 and the one or more distribution cabinets 34 of the auxiliary building 14.

As noted above, the trunk cables 20 extend between buildings 12, 14 through conduits, ducts, etc. that are laid during the construction of the datacenter 10. In a similar manner, the indoor cables 36 likewise extend between the equipment 18 and the one or more distribution cabinets 34 in the various buildings 12, 14 along conduits, ducts, raceways, etc. (also referred to hereafter as “pathways”) that are laid out during construction of the datacenter 10. As noted above, upgrades to the fiber optic network, including at datacenter 10, to increase bandwidth may be constrained by the fixed size (i.e., the cross-sectional area) of the external and internal pathways that carry the fiber optic cables 20, 36, respectively. Thus, manufacturers and installers seek solutions to provide more fiber optic capacity within a fixed size pathway. As illustrated in FIG. 4, one approach is to provide a trunk cable 20 without the strength members 28 incorporated into the fiber optic cable. By omitting the strength members 28 from the cables 20, the cross-sectional area of the cable (e.g., as provided by the maximum cross-sectional area of the cable along its length) may be reduced, such as a reduction by between about 1% and about 10%. In this way, more fiber optic cables may be accommodated in the existing external pathways of the datacenter 10. This allows bandwidth to be increased without incurring the costs associated with replacing the existing datacenter infrastructure with larger cross-sectional area pathways.

As noted above, however, the elimination of the strength members 28 in the fiber optic cable 20, while providing certain space-saving efficiencies, also brings its own challenges. Namely, without the strength members 28, conventional techniques for routing the fiber optic cables through the pathways are not available. In the conventional approach, the pull grip is anchored to the strength members in the fiber optic cable to bear the tensile loads applied to the fiber optic cable as the cable is being pulled through the pathway. But in a fiber optic cable that is lacking strength members, the question remains how to anchor the pull grip to the cable so that the tensile loads applied to the fiber optic cable during its routing through the pathway do not damage the optical fibers. Aspects of the present disclosure address this issue and provide a solution for the routing (e.g., via pulling of the pull grip) of fiber optic cables that are devoid of strength members through pathways without damaging the optical fibers carried by the fiber optic cables.

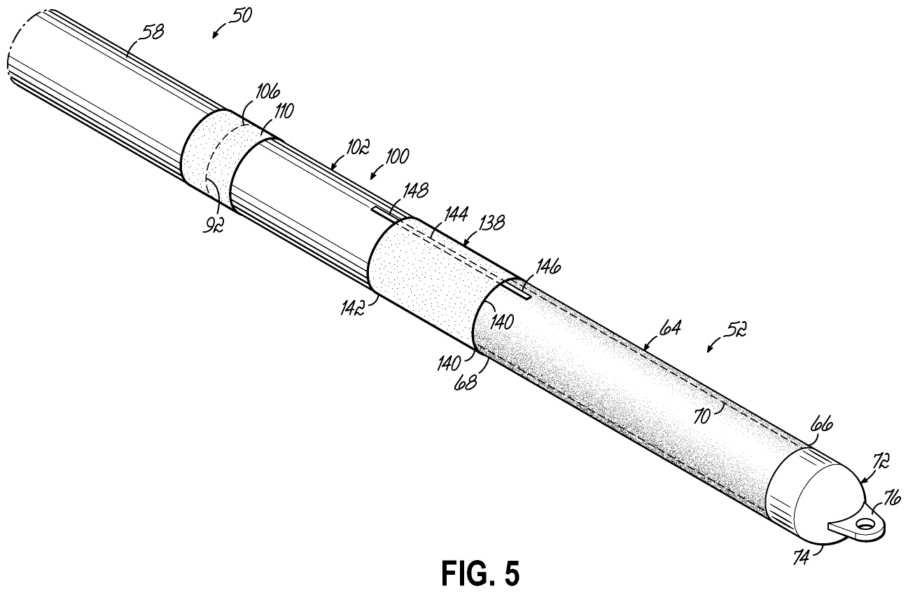

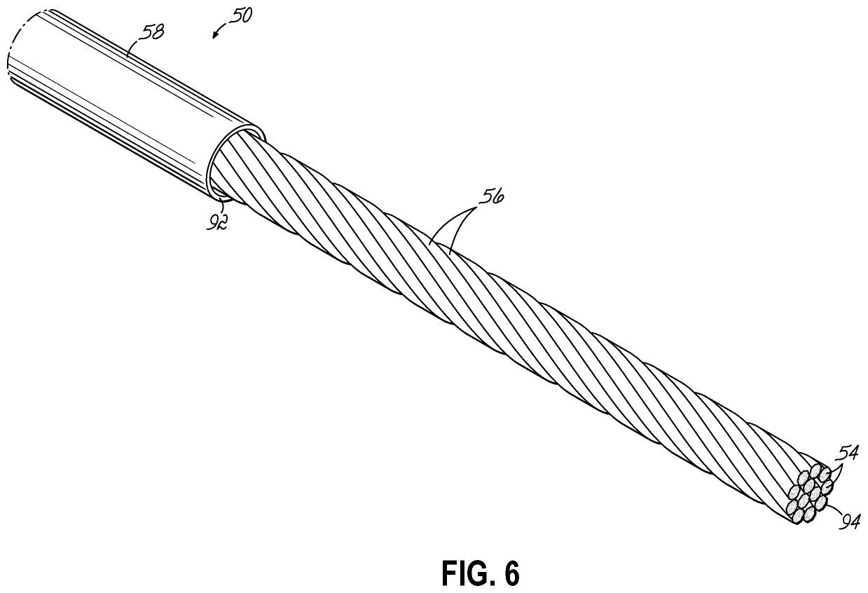

FIG. 5 illustrates a fiber optic cable 50 having a pull grip 52 connected to an end of the fiber optic cable 50 in accordance with an embodiment of the disclosure. Notably, the fiber optic cable 50 has a construction illustrated in FIG. 4 and lacks the traditional strength members of many conventional fiber optic cables. The fiber optic cable 50 may be an outdoor trunk cable, similar to trunk cable 20 described above. Aspects of the invention may also prove beneficial to an indoor cable, similar to indoor cable 36 described above. As such, and as illustrated in FIG. 4, the fiber optic cable 50 includes a plurality of optical fibers 54 extending along the length of the cable 50. In an exemplary embodiment, the plurality of optical fibers 54 may be arranged as a plurality of routable subunits 56 that are carried within the outer jacket 58 of the fiber optic cable 50. The optical fibers 54 of the routable subunits 56 may include a plurality of ribbons 60. The ribbons 60 of a routable subunit 56 may be arranged within a subunit jacket 62.

The fiber optic cable 50 is terminated by the pull grip 52, which as explained above, may be used to pull the fiber optic cable through various pathways at the datacenter 10 to establish the fiber optic network. As illustrated in FIG. 5, in an exemplary embodiment, the pull grip 52 includes an elongate tubular body 64 having a proximal end 66, distal end 68, and an interior passage 70 extending therebetween. As used herein, the term “proximal” references a location or direction more toward the end of the fiber optic cable 50 and the term “distal” refers to a location or direction away from the end of the fiber optic cable 50. In an exemplary embodiment, the tubular body 64 may be formed from a material having adequate tensile strength to accommodate the tensile loads expected during the routing of the fiber optic cable 50 in the pathway. In one embodiment, for example, the tubular body 64 may be formed from a metal, such as stainless steel, and as such, may be generally rigid in its construction. The rigidity of the tubular body 64 may also prevent the plurality of optical fibers 54, and any fiber optic connectors (referred to as “connectors”; not shown) that terminate the optical fibers 54 and contained in the interior passage 70 of the tubular body 64, from being crushed or otherwise damaged as the fiber optic cable 50 is being pulled through the pathway.

In an alternative embodiment, the tubular body 64 may be formed from a plastic material, such as a reinforced plastic material, that provides adequate tensile strength and some level of flexibility, which may improve the ability of the pull grip 52 to navigate turns in the pathway. For example, the tubular body 64 may be formed from carbon reinforced polyvinylchloride (PVC). This material may also provide some protection against crush forces to minimize damage to the optical fibers 54 and connectors contained in the interior passage 70 of the tubular body 64. Other materials may also be possible and should not be limited to the materials described herein. Moreover, in an exemplary embodiment, the tubular body 64 may be generally circular in cross section. It should be recognized, however, that other cross-sectional profiles may be possible.

The proximal end 66 of the tubular body 64 may be closed off by a pulling plug 72 (also referred to as “end cap”). In one embodiment, the pulling plug 72 may include a generally domed body 74 having a pulling eye 76 at the closed end of the domed body 74. The pulling eye 76 is configured to be coupled to a tension member (not shown) for pulling the fiber optic cable 50 through the pathway during installation. In one embodiment, the pulling plug 72 may be integrally formed with the tubular body 64 and be formed of the same material as the tubular body 64. In an alternative embodiment, however, the pulling plug 72 may be a separate element and securely coupled to the tubular body 64. In this embodiment, the pulling plug 72 may be formed from a material having adequate tensile strength to accommodate the tensile loads expected during the routing of the fiber optic cable 50 in the pathway. The material of the pulling plug 72 may be, for example, the same as or different from the material of the tubular body 64. In exemplary embodiments, the pulling plug 72 may be adhesively bonded to the tubular body 64 or welded to the tubular body 64 to generally provide a liquid-tight seal between the tubular body 64 and the pulling plug 72. Other means of attaching the pulling plug 72 to the tubular body 64 may also be possible.

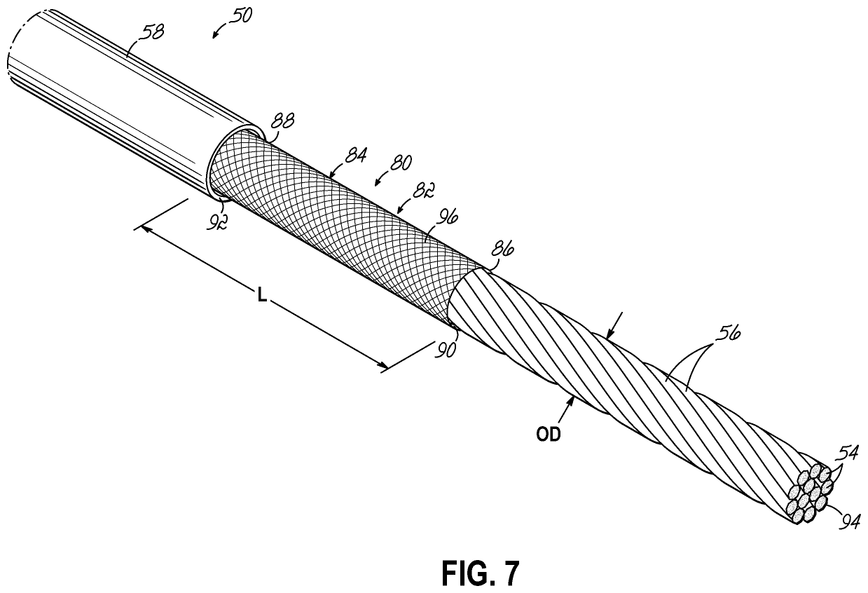

The distal end 68 of the tubular body 64 is connected to the fiber optic cable 50 for transferring the tensile loads applied to the pull grip 52 (e.g., via the tensile member connected to the pulling eye 76 of the pulling plug 72) to the fiber optic cable 50. Since the fiber optic cable 50 lacks the conventional strength members, this connection between the pull grip 52 and the fiber optic cable 50 takes on added significance. In this regard, and as will be described in more detail below, embodiments of the disclosure include a load distribution member 80 (FIG. 7) operatively disposed between and connected to the pull grip 52 and the plurality of optical fibers 54 carried by the fiber optic cable 50. The load distribution member 80 distributes the tensile loads applied to the pull grip 52 to the plurality of optical fibers 54 in a manner that is relatively uniform, thereby reducing localized, peak tensile loads on the optical fibers 54. A concept of the present disclosure is that instead of using strength members of a fiber optic cable to accommodate the expected tensile loads experienced during the routing of the fiber optic cable through a pathway, the collective strength of the optical fibers carried by the fiber optic cable is utilized to accommodate the expected tensile loads. If the fiber optic cable carried just a few optical fibers, such a fiber optic cable might be easily damaged during installation of the cable through the pathway. But when the fiber optic cable carries a high number of optical fibers, such as many hundreds or thousands optical fibers, those optical fibers collectively may provide sufficient tensile strength to accommodate the tensile loads expected during the routing of the fiber optic cable in the pathway. By way of example, and without limitation, a fiber optic cable having more than 1,000 optical fibers 54, preferably more than 1,300 optical fibers 54, and more preferably more than 1,500 optical fibers 54 may be ideal for use with the load distribution member 80 of the present disclosure.

In this regard, the present disclosure provides a mechanism for harnessing the tensile strength of collective optical fibers in a fiber optic cable to accommodate the tensile loads experienced during installation of the fiber optic cable through a pathway. That mechanism is provided by the load distribution member 80 introduced above. The details of the load distribution member 80, and how the example fiber optic cable 50 having such a load distribution member 80 may be constructed and used, will now be described in reference to FIGS. 6-11.

In a first step of a process of preparing the fiber optic cable 50 for installation through a pathway, and as illustrated in FIG. 6, the outer jacket 58 of the fiber optic cable 50 may be removed or stripped to expose a working length of the plurality of optical fibers 54, such as a working length of the plurality of routable subunits 22 of the fiber optic cable 50. Various devices for removing the outer jacket 58 of the fiber optic cable 50 are generally well known in the fiber optic industry and thus a further explanation of such devices and their use will not be described herein. In one embodiment, the plurality of optical fibers 54 of the fiber optic cable 50 may be left unterminated, i.e., no connectors or other connection interfaces installed on the optical fibers that would facilitate an optical connection to another optical device. Alternatively, however, the plurality of optical fibers 54 may be terminated by one or more connectors, connection interfaces, etc. (not shown). By way of example, and without limitation, the optical fibers 54 may be terminated by a plurality of connectors that are staggered along the working length of the optical fibers 54. Staggering the connectors along the working length minimizes the cross-sectional area at any one location along the length of the fiber optic cable being terminated by connectors. In any event, in the embodiment where the plurality of optical fibers 54 are terminated, the optical fibers 54 may be terminated with one or more connectors or other connection interfaces at this point in the process or at other points of the process, as will be described below.

In a second step of the process, and as illustrated in FIG. 7, the load distribution member 80 may be disposed about the plurality of optical fibers 54, such as disposed about the routable subunits 56 of the fiber optic cable 50. In an exemplary embodiment, the load distribution member 80 includes a squeeze tube 82. The squeeze tube 82 includes an elongate tubular body 84 having a proximal end 86, a distal end 88, and an interior passage 90 extending therebetween. The squeeze tube 82 is generally positioned adjacent the cut end 92 of the outer jacket 58, such that; i) the distal end 88 of the squeeze tube 82 abuts or is slightly distal of the cut end 94 of the outer jacket 58; ii) the plurality of optical fibers 54 extend through the interior passage 90 of the squeeze tube 82; and iii) the proximal end 86 of the squeeze tube 82 is between the cut end 92 of the outer jacket 58 and the end 94 of the optical fibers 54. In an exemplary embodiment, the squeeze tube 82 is configured to apply a radially directed pressure to the routable subunits 56 (and the plurality of optical fibers 54) extending through the interior passage 90 of the tubular body 84. In essence, the squeeze tube 82 provides a gripping force onto the outer boundary of the collective optical fibers 54 (e.g., the braided or bundled routable subunits 56) extending through the squeeze tube 82.

In one embodiment, the radially directed pressure may be generally uniform in the circumferential direction of the tubular body 84. Moreover, the radially directed pressure may also be generally uniform along the length of the tubular body 84 in a longitudinal direction. In an alternative embodiment, however, the pressure field may be non-uniform in both the circumferential direction and the longitudinal direction. Moreover, in one embodiment, the pressure field exerted by the squeeze tube 82 on the plurality of optical fibers 54 may be fixed and invariable. For example, the pressure field exerted by the squeeze tube 82 may be established during the initial assembly of the load distribution member 80 and the fiber optic cable 50. By way of example, the squeeze tube 82 may be formed from a constrictable material having an initially expanded position but capable of being transformed to a constricted position through some external stimulus (e.g., heat shrink material). In an alternative embodiment, and as described in more detail below, the pressure field exerted by the squeeze tube 82 on the plurality of optical fibers 54 may be variable. For example, the pressure field exerted by the squeeze tube 82 may be a function of the loads applied to the fiber optic cable 50. More particularly, in an exemplary embodiment, the pressure field exerted by the squeeze tube 82 on the plurality of optical fibers 54 may be a function of the tensile load applied to the load distribution member 80 by the pull grip 52. In one or more embodiments, the squeeze tube 82 may be pre-tensioned so that a threshold level of pressure may be exerted on the plurality of optical fibers 54.

By way of example, in an exemplary embodiment, the squeeze tube 82 may be formed from a self-constricting tubular mesh 96. The self-constricting tubular mesh 96 is configured such that when the mesh is elongated in the longitudinal direction, such as by tensile loads applied to the squeeze tube 82, the mesh radially contracts to reduce the cross-sectional area of the tubular mesh, thereby increasing the grip of the squeeze tube 82 onto the plurality of optical fibers 54 extending through the squeeze tube 82. Thus, the higher the tensile load on the tubular mesh 96, the greater the pressure field exerted by the squeeze tube 82 on the optical fibers 54, and the lower the tensile load on the tubular mesh 96, the lesser the pressure field exerted by the squeeze tube 82 on the optical fibers 54. Such self-constricting meshes are generally known and commercially available, and thus a further discussion on how such a mesh is constructed and operates will be omitted for sake of brevity.

The tensile loads applied to the squeeze tube 82, e.g., via the pull grip 52, are ultimately distributed to the plurality of optical fibers 54 by way of friction forces between the squeeze tube 82 and the optical fibers 54. As is well understood, the friction forces are a product of the coefficient of friction between the squeeze tube 82 and the optical fibers 54 and the normal force at the contacting interface between the squeeze tube 82 and the plurality of optical fibers 54. The coefficient of friction is a property determined by the material of the squeeze tube 82 and the material of the optical fibers 54 and may be readily determined by one of ordinary skill. The normal force is a function of the squeeze pressure and the contact surface area Aₛ between the squeeze tube 82 and the plurality of optical fibers 54. Thus, the squeeze pressure and contact surface area Aₛ may be relatively important features for distributing the tensile loads from the load distribution member 80 to the plurality of optical fibers 54. The squeeze pressure and how that may be fixed or variable and uniform or non-uniform was discussed above.

The contact surface area Aₛ may be determined by the circumference of the plurality of optical fibers 54 extending through the squeeze tube 82 (e.g., when they are in a tight braid or bundle) multiplied by the length L of the squeeze tube 82. By way of example, and without limitation, to accommodate a 600 pound (lb) tensile load on the fiber optic cable 50, in some embodiments the contact surface area Aₛ, as provided by the circumference of the bundled optical fibers 54 and the length L of the squeeze tube 82, should be no less than about 7,500 square millimeters (mm²). More particularly, in one embodiment, the contact surface area Aₛ may be between about 7,500 mm² and about 15,000 mm². Alternatively, or at least characterized differently, to accommodate a 600 lb tensile load on the fiber optic cable 50, in some embodiments the ratio of the length L of the squeeze tube 82 and the outer diameter OD of the bundled optical fibers 54 should be between no less than about 10. More particularly, in one embodiment, the ratio may be between about 10 and about 14. Embodiments of the invention, however, are not limited to these ranges, and other values may be possible depending on the specific application, for example.

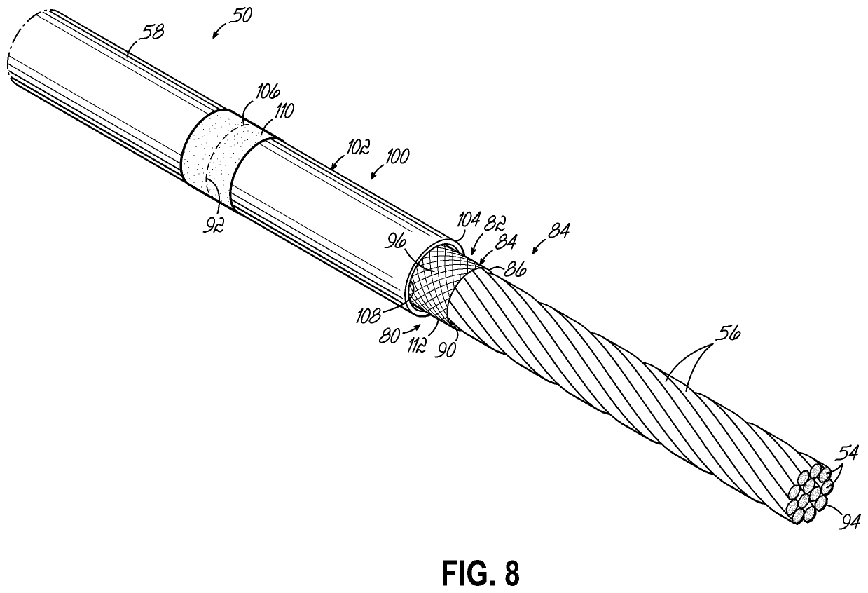

In a third step of the process, and as illustrated in FIG. 8, a protective tube 100 may be disposed over the squeeze tube 82 and is configured to cover at least a portion of the squeeze tube 82, especially adjacent the distal end 88 thereof. The protective tube 100 includes a tubular body 102 having a proximal end 104, distal end 106, and an interior passage 108 extending therebetween. In one embodiment, the protective tube 100 may be a portion of the outer jacket 58 of the fiber optic cable 50 that was previously stripped away from the end of the cable 50 to expose the plurality of optical fibers 54. Alternatively, the protective tube 100 may be a separately designed flexible tube made of a suitable plastic, for example, with or without reinforcing fibers or the like. The protective tube 100 may be disposed about the plurality of optical fibers 54 (e.g., about the routable subunits 56) such that the distal end 106 of the tubular body 102 abuts or nearly abuts the end 92 of the outer jacket 58 of the fiber optic cable 50. The distal end 106 of the protective tube 100 may be connected to the end 92 of the outer jacket 58. By way of example, in one embodiment, the distal end 106 of the protective tube 100 may be welded to the end 92 of the outer jacket 98 (not shown). In an alternative embodiment, the distal end 106 of the protective tube 100 may be coupled to the end 92 of the outer jacket 98 through a connection band 110. The connection band 110 may be a heat shrinkable band that effectively clamps the ends 92, 106 together.

The length of the protective tube 100 may be less than the length L of the squeeze tube 82 such that the proximal end 104 of the protective tube 100 is between the end 92 of the outer jacket 58 and the proximal end 86 of the squeeze tube 82. In this way, and for reasons explained below, a small region 112 of the squeeze tube 82 may be exposed outside of the protective tube 100. The protective tube 100 provides a number of functions. For example, the protective tube 100 protects the plurality of optical fibers 54 (routable subunits 56) extending through the interior passage 108 of the protective tube 100. Moreover, the connection band 110 or the welded joint creates a liquid-tight seal at the junction between the outer jacket 58 and the protective tube 100 to keep water or other liquids from accessing the optical fibers 54. Furthermore, the connection band 110 or the welded joint fixes or secures the distal end 106 of the tubular body 102, and since the tubular body 102 covers the distal end 88 of the squeeze tube 82, the connection band 110 or the welded joint can also help maintain or cause contact between the squeeze tube 82 and the plurality of optical fibers 54. This contact creates friction when tension loads are imposed on the squeeze tube 82 such that, in response to the tensile loads and as described below, the squeeze tube 82 begins to elongate and thereby constrict in a radial direction rather than slide along the outer surface of the optical fibers 54. This aspect will be described further below.

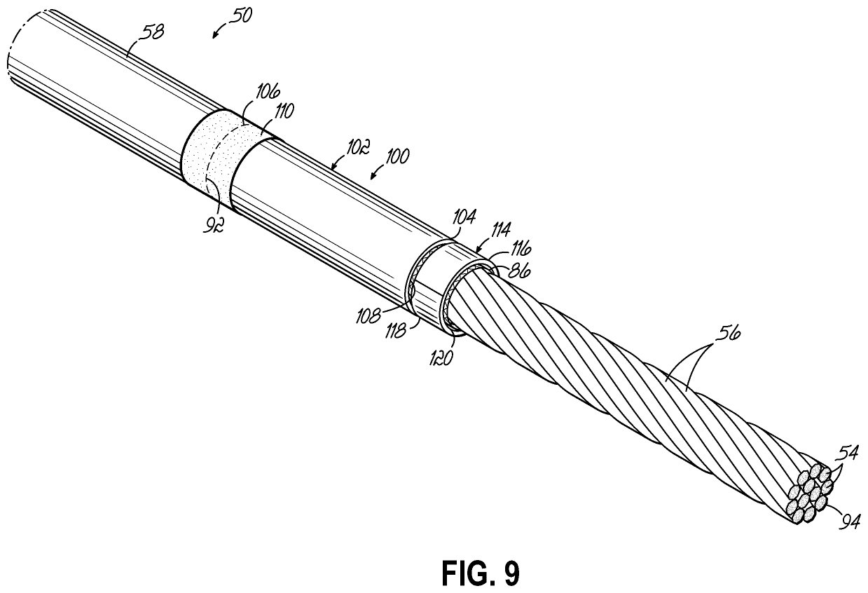

In a fourth step of the process, and as illustrated in FIG. 9, a force transfer band 114 may be attached to the squeeze tube 82 adjacent a proximal end 86 thereof. The force transfer band 114 is configured to transfer tensile loads on the pull grip 52 to the squeeze tube 82. In one embodiment, the force transfer band 114 includes a proximal end 116, a distal end 118, and an interior passage 120 extending therebetween. For example, the force transfer band 114 may comprise a crimp ring slid onto the outer surface of the tubular body 84 along the exposed region 112 thereof that is outside the protective tube 100. The distal end 118 of the force transfer band 114 may abut or nearly abut the proximal end 104 of the protective tube 100 and the proximal end 116 of the force transfer band 114 may be adjacent the proximal end 86 of the squeeze tube 82. For example, the proximal end 116 of the force transfer band 114 may be slightly distal of the proximal end 86 of the squeeze tube 82. Alternatively, however, the proximal end 116 of the force transfer band 114 may be slightly proximal of the proximal end 86 of the squeeze tube 82.

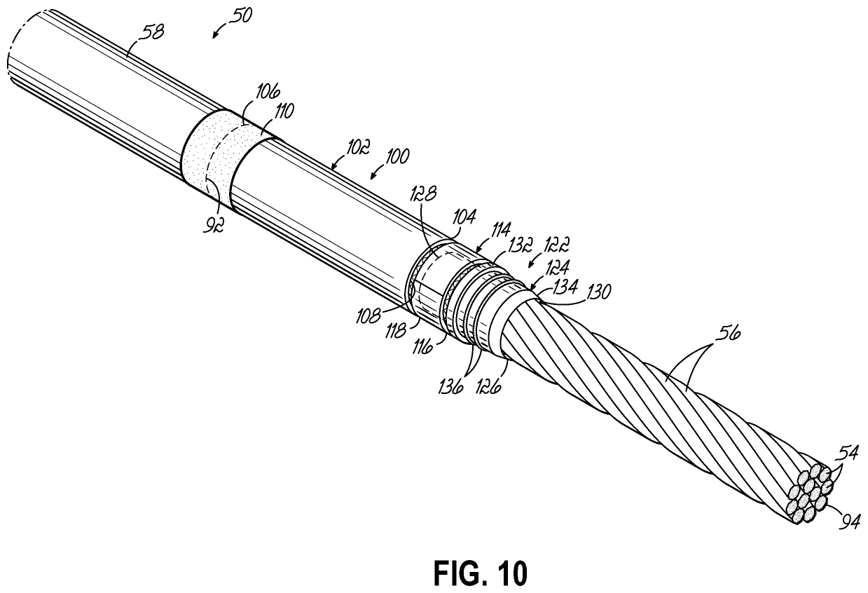

In a fifth step of the process, and as illustrated in FIG. 10, a bushing 122 may be disposed about the plurality of optical fibers 54, such as disposed about the routable subunits 56. The bushing 122 is configured to couple to the distal end 68 of the tubular body 64 but allow the plurality of optical fibers 54 to extend therethrough and into the interior passage 70 of the tubular body 64. As explained in more detail below, the bushing 122, at least in part, may aid in transferring the tensile loads on the pull grip 52, such as those generated by the tensile member connected to the pulling eye 76, to the squeeze tube 82. In an exemplary embodiment, the bushing 122 includes a tubular body 124 having a proximal end 126, a distal end 128, and an interior passage 130 extending therebetween. The bushing 122 may be formed from the same material as the tubular body 64 or from a different material that has adequate tensile strength to accommodate the tensile loads expected during the routing of the fiber optic cable 50 in the pathway.

As schematically illustrated, a distal portion of the tubular body 124 that defines the distal end 128 is shaped be received/positioned under the force transfer band 114 and under an end portion of the squeeze tube 82 leading to the proximal end 86. Thus, at least a portion of the squeeze tube 82 is positioned between the bushing 122 (specifically, the distal portion of the tubular body 124) and the force transfer band 114. At this point the force transfer band 114 may be crimped or otherwise radially compressed to couple the squeeze tube 82 to the bushing 122. In other words, the force transfer band 114 may be crimped to the bushing 122 with a portion of the squeeze tube 82 being held between the force transfer band 114 and the bushing 122. If desired, before such crimping, the proximal end 86 of the squeeze tube 82 may be secured to the bushing 122 using adhesive, a heat shrink, fasteners, or other mechanical coupling techniques. The proximal end 126 of the bushing 122 is distal of the end 94 of the optical fibers 54 such that the exposed length of the optical fibers 54 proximal of the bushing 122 fit inside the tubular body 64 of the pull grip 52.

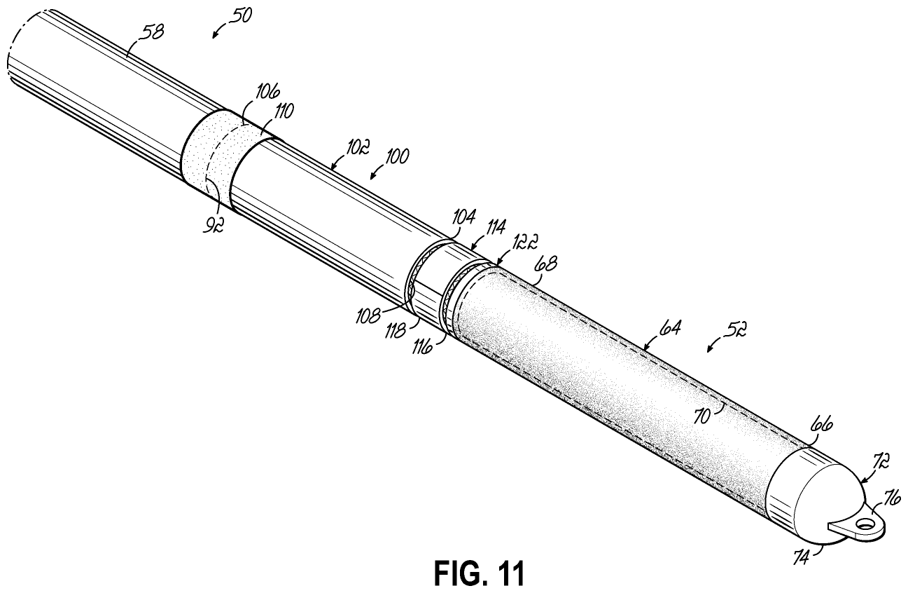

The tubular body 124 of the bushing 122 includes a portion configured to be received in the distal end 68 of the tubular body 64 of the pull grip 52. In one embodiment, the bushing 122 includes an oversized flange 132 that defines a seat configured to engage with the distal end 68 of the tubular body 64. Additionally, the proximal end 126 of the bushing 122 may include a chamfer 134 for guiding the bushing 122 into the distal end 68 of the tubular body 64. Furthermore, one or more seal members 136, such as one or more O-rings (two shown), may be disposed about the outer surface of the bushing 122 between the flange 132 and the proximal end 126 thereof. The seal members 136 are configured to engage with the inner surface of the tubular body 64 to provide a liquid-tight seal of the interior passage 70 of the tubular body 64. Thus, water or other liquids are not permitted to penetrate into the interior of the pull grip 52, either through the pulling plug 72 at the proximal end 66 of the pull grip 52 or through the bushing 122 at the distal end 68 of the tubular body 64. The bushing 122 is sized to tightly receive the plurality of optical fibers 54 through the interior passage 130 but yet allow the bushing 122 to slide over the optical fibers 54 without damaging the optical fibers 54. FIG. 11 shows the tubular body 64 disposed over the otherwise exposed optical fibers 54 and the distal end 68 of the tubular body 64 coupled to the bushing 122. Fasteners (e.g., set screws) or other types of mechanical interfaces may be used to securely couple the tubular body 64 to the portion of the bushing 122 over which the tubular body 64 is disposed. For example, in some embodiments, the tubular body 64 and bushing 122 may be configured to provide a threaded connection or bayonet connection as the mechanical interface that securely couples the two components.

In a fifth step of the process, and as illustrated in FIG. 5, a releasable connection band 138 may be positioned over at least the force transfer band 114 and a portion of the protective tube 100 that includes the proximal end 104. In an exemplary embodiment, the releasable connection band 138 may be a heat shrinkable band or other type of band that effectively provides a liquid-tight seal at the junction between the force transfer band 114 and the protective tube 100 to keep water or other liquids from accessing the optical fibers 54 (through the squeeze tube 82). The releasable connection band 138 may also be positioned over the junction between the force transfer band 114 and the bushing 122 to also provide a liquid-tight seal for that junction. In some embodiments, a proximal end 140 of the releasable connection band 138 may even be proximal of the distal end 68 of the tubular body 64

The connection band 138 may be configured to be releasable, which may be desirable, for example, to more easily remove the pull grip 52 from the bushing 122 to thereby expose the plurality of optical fibers 54 and their associated connectors in the event the optical fibers 54 are connectorized. The ability of the connection band 138 to be selectively releasable may be provided by a rip cord 144 that extends inside of the connection band 138 and along the full length, or the majority of the length, of the connection band 138. In one embodiment, the rip cord 144 has opposed proximal and distal ends 146, 148 that extend beyond the respective proximal and distal ends 140, 142 of the connection band 138. One of the proximal end 146 or the distal end 148 of the rip cord 144 may be fixedly secured to its adjacent underlying body, such as by an adhesive or the like. The other of the proximal end 146 or the distal end 148 of the rip cord 144 may be free and therefore be pulled away from its underlying surface to sever or otherwise separate the connection band 138. Severing the connection band 138 makes the connection band 138 easier to remove from the fiber optic cable 50, which may be desired to better access—or at least not interfere with—releasing the connection between the pull grip 52 and the bushing 122. As mentioned above, such a connection may use fasteners (e.g., set screws), threads, bayonet interfaces, or the like. Releasing that connection allows the pull grip 52 to be pulled proximally off of the fiber optic cable 50 to thereby expose the optical fibers 54 and any connectors terminating the optical fibers 54.

An exemplary method of routing a fiber optic cable through a pathway of a fiber optic network, such as the fiber optic network 16 at a datacenter 10, will now be described. In a first step of the method, the pull grip 52 may be coupled to an end of the fiber optic cable 50 in the manner described above. In an exemplary embodiment, the fiber optic cable 50 having the pull grip 52 connected thereto is illustrated in FIG. 5. In a second step, a tension member (not shown) is connected to the pulling eye 76 on the pulling plug 72 of the pull grip 52 and the fiber optic cable 50 is pulled through the pathway (also not shown). In the exemplary embodiment described above, the tensile load imposed on the pull grip 52 from the tension member is transferred through the pull grip 52, and through the bushing 122. Because the force transfer band 114 secures the squeeze tube 82 to a portion of the bushing 122, the load is also transferred to the squeeze tube 82, which operates as the load distribution member 80. As mentioned above, with the squeeze tube 82 held between the optical fibers 54 and the protective tube 100, there is at least some friction so that in response to the tensile load the squeeze tube 82 begins to elongate and thereby radially constrict rather than slide along the outer surface of the optical fibers 54. As the tensile load that is transferred to the squeeze tube 82 increases, so does the radially directed squeeze pressure on the plurality of optical fibers 54 extending through the interior passage 90 of the squeeze tube 82. Thus, the gripping force of the squeeze tube 82 on the optical fibers 54 may increase and decrease with the increase and decrease in the tensile load transferred to the squeeze tube 82. The radially directed squeeze pressure from the squeeze tube 82 is distributed to the plurality of optical fibers 54 across the contact surface area Aₛ between the inner surface of the squeeze tube 82 and the outer surface of the bundled optical fibers 54.

The general uniformity of the squeeze pressure and the size of the contact surface area Aₛ may be selected such that the peak tensile loads experienced by the optical fibers 54 are below the tensile strength of the optical fibers 54. In this way, damage to any of the optical fibers 54 due to the tensile loads typically experienced during the routing of the fiber optic cable 50 through the pathway may be avoided. By using the combined tensile strength of the (numerous) optical fibers 54 in the fiber optic cable 50 to accommodate the tensile loads on the pull grip 52 during routing of the fiber optic cable 50, strength members in the fiber optic cable 50 may be omitted without losing the ability to effectively pull (and thereby route) the cable 50 through the pathway. This, in turn, allows the cross-sectional dimension (e.g., such as a maximum cross-sectional dimension along the length of the cable 50) to be reduced as compared to fiber optic cables with strength members. Accordingly, the ability of existing conduits or other pathways to fit more optical fibers 54 (i.e., increase the optical fiber density in the pathways) is improved. Moreover, because the strength members have been omitted in the fiber optic cable 50 and the load distribution member 80 taps into the collective tensile strength of the plurality of optical fibers 54, a furcation housing, which normally operates as an anchoring point for the pull grip in conventional fiber optic cables, may also be omitted from the fiber optic cable. This again may allow the maximum cross-sectional dimension along the length of the fiber optic cable 50 to be reduced as compared to cables with strength members and furcation housings.

When the end of the fiber optic cable 50 is pulled through the pathway and is located in its desired location, the pull grip 52 may be removed from the fiber optic cable 50. For example, the fiber optic cable 50 may be a trunk cable 20 and the pathway may be an external pathway. In this case, the trunk cable 50 may be pulled through the external pathway until the end is positioned in the main building 12 or one of the auxiliary buildings 14, and more particularly is positioned for connection within a distribution cabinet 34. In this case, when the end of the fiber optic cable 50 is in the desired position, the pull grip 52 may be removed from the end of the cable 50. As explained above, this may be achieved by pulling on one of the ends 146, 148 of the rip cord 144 to sever the releasable connection band 138 and thereafter releasing the connection between the tubular body 64 of the pull grip 52 and the bushing 122. This allows the pull grip 52, including the pulling plug 74 and the tubular body 64, to be pulled from the end of the cable 50 to expose the ends of the plurality of optical fibers 54. These ends may be connectorized and include one or more connectors for making an optical connection with other optical devices. In this embodiment, the connection band 110, the protective tube 100, the squeeze tube 82, the force transfer band 114, and the bushing 122 may remain on the fiber optic cable 50 after the pull grip 52 is removed. In alternative embodiments, however, one or more of these elements may also be removed from the fiber optic cable 50.

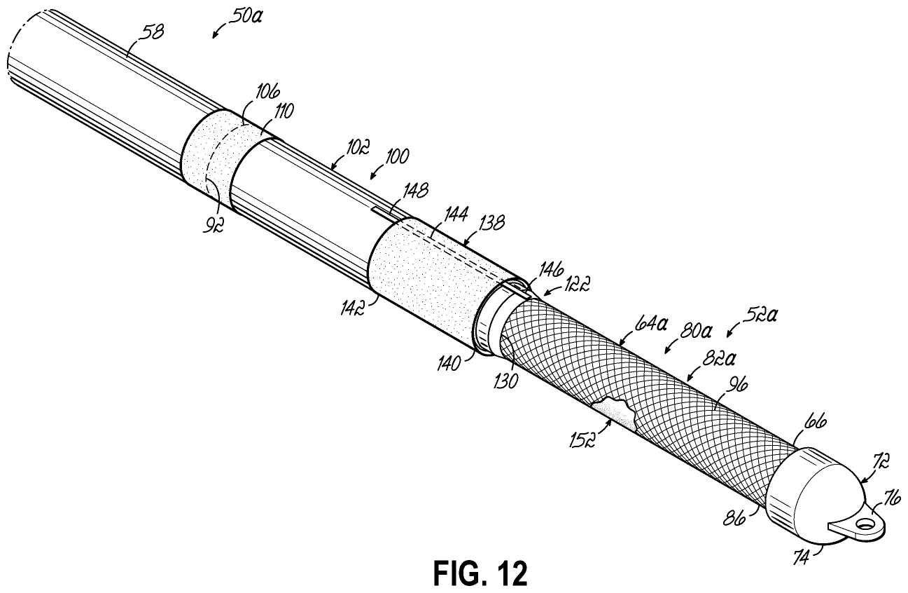

FIG. 12 illustrates a fiber optic cable 50a having a pull grip 52a connected to the end of fiber optic cable 50a in accordance with further alternative embodiment according to the disclosure. Fiber optic cable 50a is similar to fiber optic cable 50 described above and only differences between the two cables will be described in further detail. The primary difference is that the pull grip 52a and the load distribution member 80a are integrated. More particularly, the squeeze tube 82a, in addition to serving as the load distribution member 80a, also serves as the tubular body 64a of the pull grip 52a.

Similar to the fiber optic cable 50 and as described above, the outer jacket 58 of the fiber optic cable 50a may be stripped to expose a working length of the plurality of optical fibers 54. The load distribution member 80a, which may include a squeeze tube 82a and may take the form of a tubular mesh 96, may be disposed about the plurality of optical fibers 54, such as disposed about the routable subunits 56 of the fiber optic cable 50a. The distal end 88 of the squeeze tube 82a abuts or is slightly distal of the end 94 of the outer jacket 58 and the plurality of optical fibers 54 extend through the interior passage of the squeeze tube 82a. Unlike the other example embodiment discussed above, however, the proximal end 86 of the squeeze tube 82a is positioned adjacent the end 94 of the optical fibers 54. In other words, the squeeze tube 82a extends proximally relative to that shown above in FIG. 7 so that the proximal end 86 of the squeeze tube 82a is adjacent or past the end 94 of the optical fibers 54. The protective tube 100 may be disposed over the squeeze tube 82a, especially adjacent the distal end 88 of the squeeze tube 82a. The distal end 106 of the protective tube 100 abuts or nearly abuts the end 92 of the outer jacket 58 of the fiber optic cable 50a and is coupled to the outer jacket 58 through a welded connection or a connection band 110.

A stability band (not shown), such as a crimp band or the like, may be connected to the squeeze tube 82a just proximal of the protective tube 100 similar to the force transfer band 114 shown and described above. In such an embodiment, the stability band does not operate as a force transfer band but instead is used to stabilize and support the squeeze tube 82a.

As noted above, instead of using a stainless steel or a fiber reinforced PVC tube, the tubular body 64a of the pull grip 52a may be provided by tubular mesh 96 that forms the squeeze tube 82a. In one embodiment, a pulling plug 72, similar to that described above, may be coupled to the proximal end 66 of the tubular body 64a. In an alternative embodiment, the pulling plug 72 may be formed of mesh material and integrated with the tubular body 64a. The separate or integrated pulling plug may also include the pulling eye 76 for the purpose described above. As described above, when a tensile load is applied to the pull grip 52a, such as when routing the fiber optic cable 50a through a pathway (not shown), the squeeze tube 82a will constrict radially. This includes not only along the portion of the squeeze tube 82a distal of the stability band (similar to the above), but also includes the portion of the squeeze tube 82a between the stability band and the pulling plug 72.

The constriction of the squeeze tube 82a is not problematic if the optical fibers 54 of the fiber optic cable 50a are unterminated, i.e., lacking connectors or the like proximal of the stability band. In this case, pulling the fiber optic cable 50a through the pathway results in a radially directed squeeze pressure on the plurality of optical fibers 54 both distally and proximally of the stability band similar to that described above. The tensile load imposed on the pulling plug 72 is distributed to the plurality of optical fibers 54 similar to that described above but having a significantly increased contact surface area Aₛ between the squeeze tube 82a and the plurality of optical fibers 54.

In this embodiment, when the end of the fiber optic cable 50a reaches its desired location after being pulled through the pathway, the pull grip 52a may be removed. As illustrated in FIG. 12, the stability band may be covered with the releasable connection band 138 and rip cord 144 as described above. To remove the pull grip 52a, the rip cord 144 may be pulled to sever the connection band 138. This exposes the stability band and portions of the squeeze tube 82a and portions of the protective tube 100. To remove the pull grip 52a, the squeeze tube 82a may be cut or severed at a location just proximal of the stability band. After being cut, the pulling plug 72 and the tubular body 64a formed by a proximal portion of the squeeze tube 82a (i.e., tubular mesh 96) may be slidingly removed from the end of the fiber optic cable 50a to expose the plurality of optical fibers 54. Similar to the above, however, a distal portion of the squeeze tube 82a, the stability band, the protective tube 100 and the connection band 110 may remain part of the fiber optic cable 50a after the pull grip 52a is removed.

The embodiment described above may be slightly different in the event that the plurality of optical fibers 54 are terminated with connectors or connection interfaces (e.g., ferrules). In such an embodiment, the pull grip 52a may further include a further protective tube 152 on the inside of the squeeze tube 82a so as to be disposed between the squeeze tube 82a and the plurality of optical fibers 54. The protective tube 152 may have adequate hoop strength to prevent the connectors from being crushed, and thus damaged, as a result of the constriction of the squeeze tube 82a due to the tensile loads being imposed on the fiber optic cable 50a. The protective tube 152 may be formed from a suitable plastic, for example. The proximal end of the protective tube 152 may be coupled to the pulling plug 72 of the pull grip 52a. Additionally, a distal end of the protective tube 152 may be coupled to a bushing (not shown) similar to the bushing 122 described above and positioned on the plurality of optical fibers 54 adjacent to the stability band.

To remove the pull grip 52a in this embodiment, the rip cord 144 may be pulled to sever the connection band 138. This exposes the stability band, portions of the squeeze tube 82a, and portions of the protective tube 100. The bushing of the pull grip 52a, though being covered by the squeeze tube 82a, may be identifiable and be adjacent the stability band. To remove the pull grip 52a, the squeeze tube 82a may be cut at a location just proximal of the stability band and just distal of the bushing. After being cut, the pulling plug 72, the tubular body 64a formed by a proximal portion of the squeeze tube 82a (e.g., tubular mesh 96), the protective tube 152, and the bushing may be slidingly removed from the end of the fiber optic cable 50a to expose the plurality of optical fibers 54 and their associated connectors or connection interfaces. Similar to the above, however, the distal portion of the squeeze tube 82a, the stability band, the protective tube 100 and the connection band 110 may remain part of the fiber optic cable 50a.

While the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The disclosure in its broader aspects is therefore not limited to the specific details, representative apparatus and methods and illustrative examples shown and described. Accordingly, departures may be made from such details without departing from the scope of the disclosure.

What is claimed is:

1. A fiber optic cable, comprising:
an outer jacket;
a plurality of optical fibers carried within the outer jacket;
a pull grip at an end of the fiber optic cable for pulling the fiber optic cable through a pathway, the pulling of the fiber optic cable through the pathway causing a tensile load to be imposed on the fiber optic cable; and
a load distribution member coupled to the pull grip and to the plurality of optical fibers, the load distribution member configured to distribute the tensile load imposed on the fiber optic cable over the plurality of optical fibers such that the plurality of optical fibers collectively provides the tensile strength to support the tensile load on the fiber optic cable.

2. The fiber optic cable of claim 1, wherein the load distribution member includes a squeeze tube having an internal passage, the plurality of optical fibers extending through the internal passage, and wherein the squeeze tube is configured to apply a squeeze pressure to the plurality of optical fibers.

3. The fiber optic cable of claim 2, wherein the squeeze tube is configured so that the squeeze pressure is variable.

4. The fiber optic cable of claim 2, wherein the squeeze tube includes a self-constricting tubular mesh.

5. The fiber optic cable of claim 1, wherein at least a portion of the pull grip is formed by the load distribution member.

6. The fiber optic cable of claim 1, wherein the pull grip comprises:
a tubular body having a proximal end, a distal end, and an internal passage;
a pulling plug at the proximal end of the tubular body for connection to a tension member for pulling the fiber optic cable through the pathway; and
a bushing at the distal end of the tubular body, the bushing permitting the plurality of optical fibers to pass into the internal passage of the tubular body.

7. The fiber optic cable of claim 6, wherein the load distribution member further comprises a force transfer band, and wherein the fiber optic cable further comprises a releasable connection band connecting the bushing of the pull grip and the force transfer band of the load distribution member, the releasable connection band configured to transfer the tensile load on the pull grip to the load distribution member.

8. The fiber optic cable of claim 7, wherein the releasable connection band includes a rip cord for severing the connection between the pull grip and the load distribution member, and wherein the pull grip is slidingly removable from the end of the fiber optic cable upon severance of the connection band.

9. The fiber optic cable of claim 1, further comprising a protective tube covering at least a portion of the load distribution member and connected to the outer jacket of the fiber optic cable.

10. The fiber optic cable of claim 1, wherein the load distribution member engages with the plurality of optical fibers over a contact surface area of no less than about 7,500 mm².

11. The fiber optic cable of claim 10, wherein the contact surface area is between about 7,500 mm² and about 15,000 mm².

12. The fiber optic cable of claim 1, wherein the load distribution member engages with the plurality of optical fibers over a contact surface area having a length along the plurality of optical fibers, and wherein the ratio of the length of the contact surface area and an outer diameter of the plurality of optical fibers is no less than about 10.

13. The fiber optic cable of claim 12, wherein the ratio of the length of the contact surface area and the outer diameter of the plurality of optical fibers is between about 10 and about 14.

14. The fiber optic cable of claim 1, wherein the number of optical fibers in the plurality of optical fibers exceeds 1,000 optical fibers, preferably exceeds 1,300 optical fibers, and more preferably exceeds 1,500 optical fibers.

15. The fiber optic cable of claim 1, wherein the fiber optic cable lacks strength members extending along the length of the fiber optic cable.

16. A fiber optic cable, comprising:
an outer jacket;
a plurality of optical fibers carried within the outer jacket;
a pull grip at an end of the fiber optic cable for pulling the fiber optic cable through a pathway, the pulling of the fiber optic cable through the pathway causing a tensile load to be imposed on the fiber optic cable; and
a load distribution member coupled to the pull grip and to the plurality of optical fibers, the load distribution member configured to distribute the tensile load imposed on the fiber optic cable over the plurality of optical fibers such that the plurality of optical fibers collectively provides the tensile strength to support the tensile load on the fiber optic cable, wherein:
the load distribution member includes a squeeze tube having an internal passage through which the plurality of optical fibers extend,
the squeeze tube is configured to apply a squeeze pressure to the plurality of optical fibers, and
the squeeze tube is configured so that the squeeze pressure is a function of the tensile load imposed on the fiber optic cable.

17. The fiber optic cable of claim 16, wherein the load distribution member engages with the plurality of optical fibers over a contact surface area of no less than about 7,500 mm².

18. The fiber optic cable of claim 17, wherein the contact surface area is between about 7,500 mm² and about 15,000 mm².

19. The fiber optic cable of claim 18, wherein the ratio of the length of the contact surface area and the outer diameter of the plurality of optical fibers is between about 10 and about 14.

20. The fiber optic cable of claim 16, wherein the fiber optic cable lacks strength members extending along the length of the fiber optic cable.
